(19) United States
(12) Patent Application Publication
(10) Pub. No.: US 2005/0227732 A1
(43) Pub. Date: Oct. 13, 2005

(54) Base station for radio communication, radio communication method and mobile station

(75) Inventor: Hirochika Hiraki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/503,638

(22) PCT Filed: May 7, 2002
(86) PCT No.: PCT/JP02/04434

§ 371 Date: Aug. 5, 2004

(51) Int. Cl. H04M 1/00

(52) U.S. Cl. 455/561

(57) ABSTRACT

A base station, which implements a compressed mode before a hard handover, measures transmission power and received power. In response to the measured transmission power and received power, a controller calculates a value associated with transmission delay. The controller corrects a transmission period for transmitting a frame unit in a compressed mode in response to the value associated with the transmission delay.

### TECHNICAL FIELD

The present invention relates to a base station for radio communication, a radio communication method and a mobile station capable of operating in a compressed mode for achieving hard handover.

### BACKGROUND ART

In a mobile communication system, when a mobile station moves to the cell of a second base station during communication with a first base station, a handover is carried out so that the communication is carried out between the new base station and the mobile station. As a method of the handover of a mobile station from a first base station to a second base station, there are two schemes: a hard handover involving interruption of communication; and a soft handover (diversity handover) without involving interruption of communication. It is possible for a mobile communication system employing CDMA (code division multiple access) to carry out the soft handover as long as the carrier frequencies used by the first and second base stations are the same.

On the other hand, it is not unlikely that a first base station uses a carrier with a frequency different from that of a second base station in such a mobile communication system in which a UMTS (universal mobile terrestrial communication system) coexists with a GSM (group specific mode) system, or a composite mobile communication system in which networks of different carriers are combined. When the mobile station moves between the cells of these base stations, it is necessary to switch the frequency of the mobile station as well as to carryout the handover. In this case, since the communication interruption is unavoidable, the hard handover is performed.

According to a typical method of the frequency switching handover, the current base station communicating with the mobile station enters into a compressed mode for the handover. In the compressed mode, the current base station compresses the length of a frame on a traffic channel (increases the transmission rate), increases the transmission power by that amount, and transmits significant data or speech through the traffic channel. Accordingly, the current base station has an idle period during which it does not transmit any frame. Using the perch channel between other base stations and the mobile station during the idle period, the mobile station measures the carrier intensity levels of the other base stations, and determines the base station that can achieve the best quality communication.

The information about the new base station determined is sent from the mobile station to a base station control system via the current base station. Then, the base station control system commands the new base station to establish communication with the mobile station, and the current base station to relinquish the communication with the mobile station. Thus, the new base station starts communication with the mobile station.

Since the conventional base station for radio communication has the foregoing configuration, the mobile station can identify the new available base station, and restarts the communication using the new base station. The method, however, has a problem in that a frame on the traffic channel may be corrupted in the compressed mode because of transmission delay.

The problem will be described more concretely. In the compressed mode, the transmission time period and idle period of a frame unit of the base station is predetermined. If the transmission delay is zero or fixed, the mobile station can receive the entire signal train in the frame unit as long as it operates based on the predetermined transmission time period and idle period. However, since the transmission delay has jitter, it is difficult to plan the receiving operation of the mobile station after estimating the transmission delay in advance. If the transmission delay increases, the time period for receiving the entire frame unit will exceed a prescribed frame receiving time period in the mobile station. In this case, the final portion of the frame unit arrives at the mobile station during the prescribed idle period of the mobile station. However, since the mobile station carries out the receive processing using the perch channel during the idle period, the mobile station cannot process the final portion of the frame unit. Consequently, the frame unit on the traffic channel is corrupted during the reception, thereby bringing about degradation in the service quality.

The present invention is implemented to solve the foregoing problem. Therefore it is an object of the present invention to provide a base station for radio communication, a radio communication method and a mobile station capable of preventing or suppressing partial corruption of the frame unit sent from the current base station to the mobile station in the compressed mode.

### DISCLOSURE OF THE INVENTION

According to one aspect of the present invention, there is provided a base station for radio communication including: a radio transmitting section for transmitting a signal train to a mobile station; a radio receiving section for receiving a signal train from the mobile station; a mode control section for controlling the radio transmitting section in a manner that implements a compressed mode to enable communication for determining a new base station the mobile station uses after a hard handover, the compressed mode being a mode in which the radio transmitting section transmits the signal train intermittently to the mobile station; a transmission power measuring section for measuring transmission power at which the radio transmitting section transmits the signal train; a received power measuring section for measuring received power of the signal train received by the radio receiving section; a calculating section for calculating a value associated with transmission delay from measured results of the transmission power measuring section and the received power measuring section; and a correcting section for correcting a transmission period of the signal train in the compressed mode in response to the value associated with the transmission delay.

Thus, the base station can correct the transmission period of the signal train in the compressed mode in response to the transmission delay. Accordingly, the base station can adjust the transmission period of the signal train sent from the current base station to the mobile station in the compressed mode in a manner that enables the mobile station to perform the receive processing. As a result, it is possible to prevent or suppress partial corruption of the signal train. In addition, it offers an advantage that the mobile station need not change the scheduled receive processing timing to achieve the foregoing benefit.

In the base station, the calculating section may calculate a difference between a transmission stop time of the signal train transmitted by the radio transmitting section and a receiving stop time of the signal train which corresponds to the signal train and is received by the radio receiving section, and the correcting section may set a transmission start time of the signal train transmitted by the radio transmitting section ahead of scheduled time in response to the difference. Thus, the base station can adjust the transmission start time of the signal train in a manner that advances the transmission start time of the signal train according to the actual transmission stop time of the base station itself and the receiving stop time of a response from the mobile station. Even if the transmission delay is present, as long as it is not large, advancing the transmission start time enables the mobile station to complete the entire receive processing of the signal train during the prescribed receive processing period.

In the base station, the calculating section may calculate a transmitting section idle period during which the radio transmitting section does not actually transmit the signal train, calculate a receiving section idle period during which the radio receiving section does not actually receive the signal train, and calculate a difference between the transmitting section idle period and the receiving section idle period, and the correcting section may set a transmission stop time of the signal train transmitted by the radio transmitting section ahead of scheduled time in response to the difference. Thus, the base station can adjust the transmission stop time of the signal train in a manner that advances the transmission stop time of the signal train according to the transmitting section idle period and the receiving section idle period. Even if the transmission delay is present, as long as it is not large, advancing the transmission stop time enables the mobile station to complete the entire receive processing of the signal train during the prescribed receive processing period.

The base station may further comprise a retransmission control section for controlling the radio transmitting section in a manner that the radio transmitting section retransmits the signal train to the mobile station if the value associated with the transmission delay exceeds a threshold value. Thus, the frame unit whose receive processing has failed in the mobile station is retransmitted so that the mobile station can carry out the receive processing under improved reliability.

The base station may further comprise: a retransmission signal train request section for asking a radio network controller for a signal train to be retransmitted to the mobile station when the value associated with the transmission delay exceeds a threshold value; a retransmission signal radio receiving section for receiving the signal train to be retransmitted from the radio network control unit; and a retransmission control section for controlling the radio transmitting section in a manner that the radio transmitting section retransmits the signal train to be retransmitted to the mobile station. Thus, the frame unit whose receive processing has failed in the mobile station is retransmitted so that the mobile station can carry out the receive processing under improved reliability.

According to another aspect of the present invention, there is provided a radio communication method in a base station for radio communication including the steps of: transmitting a signal train from a radio transmitting section to a mobile station; receiving a signal train from the mobile station by a radio receiving section; controlling the radio transmitting section in a manner that implements a compressed mode to enable communication for determining a new base station the mobile station uses after a hard handover, the compressed mode being a mode in which the radio transmitting section transmits the signal train intermittently to the mobile station; measuring transmission power at which the radio transmitting section transmits the signal train; measuring received power of the signal train received by the radio receiving section; calculating a value associated with transmission delay from the transmission power and received power measured; and correcting a transmission period of the signal train in the compressed mode in response to the value associated with the transmission delay.

Thus, the base station can correct the transmission period of the signal train in the compressed mode in response to the transmission delay. Accordingly, the base station can adjust the transmission period of the signal train sent from the current base station to the mobile station in the compressed mode in a manner that enables the mobile station to perform the receive processing. As a result, it is possible to prevent or suppress partial corruption of the signal train. In addition, it offers an advantage that the mobile station need not change the scheduled receive processing timing to achieve the foregoing benefit.

According to still another object of the present invention, there is provided a mobile station for radio communication including: a radio transmitting section for transmitting a signal train to a base station; a radio receiving section for receiving a signal train from the base station;
a receive processing section for processing the signal train received by the radio receiving section; a mode control section for controlling the receive processing section in a manner that the receive processing section processes the signal train from the current base station intermittently to implement a compressed mode that enables the receive processing section to carry out receive processing for determining a new base station used after a hard handover, the compressed mode being a mode in which the receive processing section processes signals from candidates of the new base station during a pause in which the radio receiving section does not receive the signal train from the current base station; a received power measuring section for measuring received power of the signal train received by the radio receiving section; a calculating section for calculating a value associated with transmission delay from measured results of the received power measuring section; and a correcting section for correcting a period of receive processing of the signal train sent from the current base station, which receive processing is carried out by the receive processing section in the compressed mode in response to the value associated with the transmission delay.

Thus, the mobile station can correct the receive processing period of the signal train in the compressed mode in response to the transmission delay. Accordingly, the mobile station can adjust the receive processing period of the signal train sent from the current base station to the mobile station in the compressed mode in a manner that enables the mobile station to perform the receive processing of the signal train sent from the base station. As a result, it is possible to prevent or suppress partial corruption of the signal train. In addition, it offers an advantage that the base station need not change the scheduled transmission timing to achieve the foregoing benefit.

In the mobile station, the calculating section may calculate a receiving section idle period during which the radio receiving section does not actually receive the signal train; and the correcting section may set a receive processing stop time of the signal train processed by the receive processing section behind scheduled time in response to the receiving section idle period. Thus, the mobile station can adjust the receive processing stop time of the signal train in a manner that delays the receive processing stop time according to the receiving section idle period. Even if the transmission delay is present, as long as it is not large, postponing the receive processing stop time enables the mobile station to complete the entire receive processing of the signal train during the modified receive processing period.

### BRIEF DESCRIPTION OF THE DRAWINGS

FIG. 1 is a schematic diagram showing a radio communication system including base stations for radio communication and a mobile station in accordance with the present invention;

FIG. 2 is a time chart illustrating a compressed mode used by the radio communication system shown in FIG. 1;

FIG. 3 is a block diagram showing an internal configuration of a base station in the radio communication system in FIG. 1 of an embodiment 1 in accordance with the present invention;

FIG. 4 is a diagram illustrating transition of the transmission power at the base station as shown in FIG. 3;

FIG. 5 is a diagram illustrating transition of the received power at the base station as shown in FIG. 3;

FIG. 6 is a diagram illustrating a combination of the diagrams of FIGS. 4 and 5;

FIG. 7 is a diagram illustrating transition of the transmission power and received power of the base station and mobile station when the transmission delay between the base station and mobile station is very small in the compressed mode;

FIG. 8 is a diagram illustrating transition of the transmission power and received power of the base station and mobile station of the embodiment 1 when the transmission delay between the base station and mobile station is rather large in the compressed mode;

FIG. 9 is a block diagram showing a part of an internal configuration of a base station in the radio communication system shown in FIG. 1 of an embodiment 2 in accordance with the present invention;

FIG. 10 is a block diagram showing a part of an internal configuration of the mobile station in the radio communication system shown in FIG. 1 of an embodiment 3 in accordance with the present invention; and

FIG. 11 is a diagram illustrating transition of the transmission power and received power of the base station and mobile station of the embodiment 3 when the transmission delay between the base station and mobile station is rather large in the compressed mode.

### BEST MODE FOR CARRYING OUT THE INVENTION

The best mode for carrying out the invention will now be described with reference to the accompanying drawings to explain the present invention in more detail.

### Embodiment 1

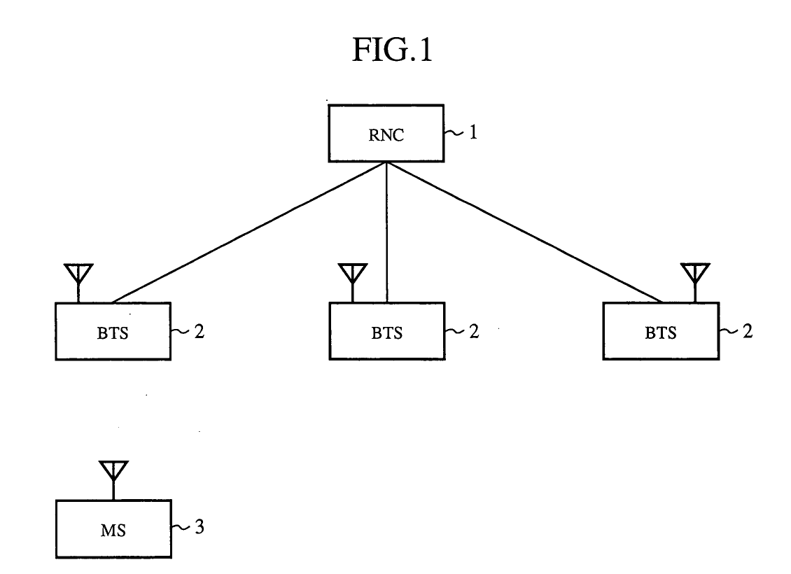

FIG. 1 shows a radio communication system including base stations and a mobile station for radio communication in accordance with the present invention. In FIG. 1, the reference numeral 1 designates an RNC (radio network controller), 2 designates a BTS (base transceiving station), and 3 designates an MS (mobile station).

Next, the operation will be described. The radio communication system employs CDMA (code division multiple access) When the MS 3 moves to the cell of a second BTS 2 during communication with a first BTS 2, a handover is carried out to establish communication between the new BTS 2 and the MS 3. If the current BTS 2 uses a carrier with a frequency different from that of the new BTS 2, and the MS 3 moves between the cells of these BTS's 2, a hard handover involving the frequency switching is carried out.

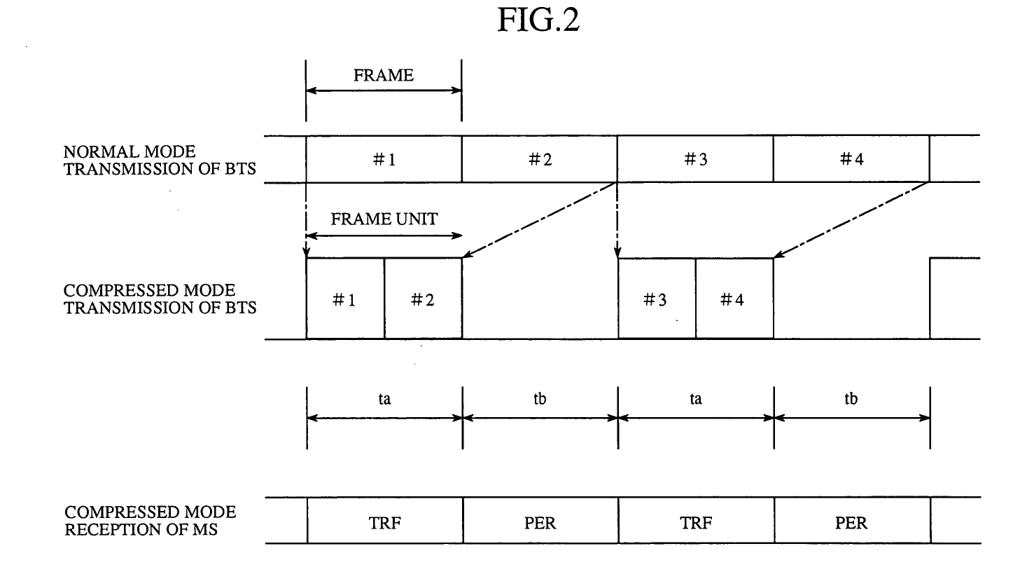

According to the frequency switching handover, the current BTS 2 communicating with the MS 3 enters into a compressed mode for the handover. FIG. 2 is a time chart illustrating the compressed mode. As illustrated in FIG. 2, the BTS 2 successively transmits frames #1, #2, . . . to the MS 3 through a traffic channel in the normal mode.

In contrast, the current BTS 2 in the compressed mode compresses the length (increases the transmission rate) of frames on the traffic channel, enhances the transmission power by that amount, and transmits significant data or speech through the traffic channel (TRF). For example, the BTS 2 in the compressed mode specifies the transmission rate twice the transmission rate in the normal mode, and doubles the transmission power temporarily to prevent the degradation due to the gain reduction because of the transmission halt. In addition, the BTS 2 successively transmits a plurality of (two, for example) frames as a first frame unit, and provides a pause between the transmission of the frame units. Accordingly, the transmission period ta of a frame unit becomes half the transmission period in the normal mode, and the frame units are transmitted intermittently. Thus, the current BTS 2 produces an idle period tb, a pause, during which it does not transmit a frame unit. During the transmission period ta of the frame unit, the MS 3 receives and processes the signal on the traffic channel (TRF). On the other hand, during the idle period tb, the MS 3 receives and processes the signal on the perch channel (PER) between the MS 3 and other BTS's 2, candidates of a new base station, measures the carrier intensity levels of these BTS's 2, and determines the BTS 2 that achieves the highest quality communication. In this way, the communication of the significant data or speech is compatible with the communication for collecting information about the handover.

The information about the newly determined BTS 2 is sent from the MS 3 to the RNC 1 via the current BTS 2. The RNC 1 commands the new BTS 2 to establish communication with the MS 3, and the current BTS 2 to relinquish communication with the MS 3. In this way, the new BTS 2 starts communication with the MS 3.

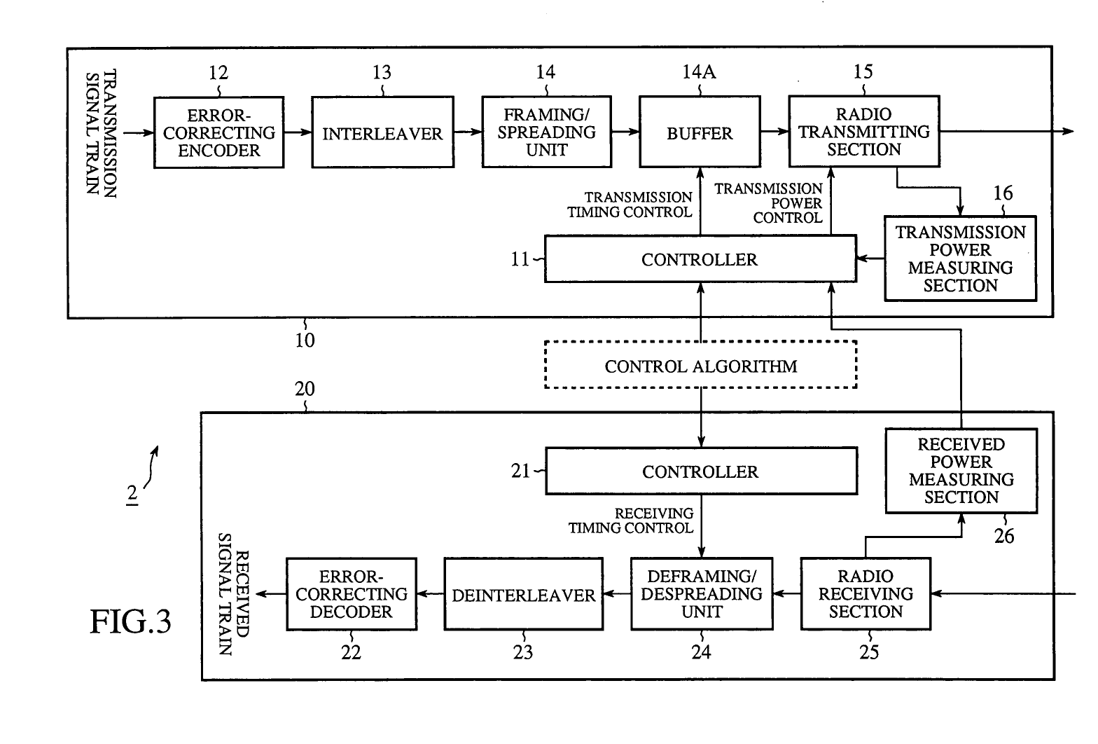

FIG. 3 shows part of the internal configuration of the BTS 2. In FIG. 3, the reference numeral 10 designates a transmitting sub-system and 20 designates a receiving sub-system. The transmitting sub-system 10 includes a controller (a mode control section, a calculating section, a correcting section, and a retransmission control section) 11, an error-correcting encoder 12, an interleaver 13, a framing/spreading unit 14, a buffer 14A, a radio transmitting section 15, and a transmission power measuring section 16.

The controller 11 controls the operation of the interleaver 13, framing/spreading unit 14, buffer 14A and radio transmitting section 15 according to a control algorithm and negotiation results with the receiving sub-system 20. The controller 11 carries out the normal mode (non-compressed mode) and compressed mode for performing the frame transmission described with reference to FIG. 2.

The error-correcting encoder 12 conducts the error-correcting coding of the transmission signal train to produce a transmission code train. The interleaver 13 rearranges the order of the bits of (interleaves) the transmission code train in order to minimize the effect of a transmission error that will occur when continuous bits in the transmission code train are lost because of fading during the transmission, for example.

The framing/spreading unit 14 spreads the transmission code train to a wide bandwidth using a spreading code assigned to each user. In addition, the framing/spreading unit 14 generates frames on the basis of the transmission code train spread. The frames generated are temporarily stored in the buffer 14A, and are read sequentially from the buffer 14A to be delivered to the radio transmitting section 15.

The controller 11 reads out the frames to be transmitted from the buffer 14A, and delivers the frames to the radio transmitting section 15 at the time of transmission. The radio transmitting section 15 transmits the frames to the MS at the radio frequency of the traffic channel. In this way, the controller 11 controls the transmission timing to carry out the frame transmission suitable for the individual modes.

In addition, the controller 11 controls the transmission rate and transmission power of the radio transmitting section 15. Specifically, the controller 11 specifies in the compressed mode the transmission rate twice the transmission rate in the normal mode, and the transmission power about twice that of the normal mode.

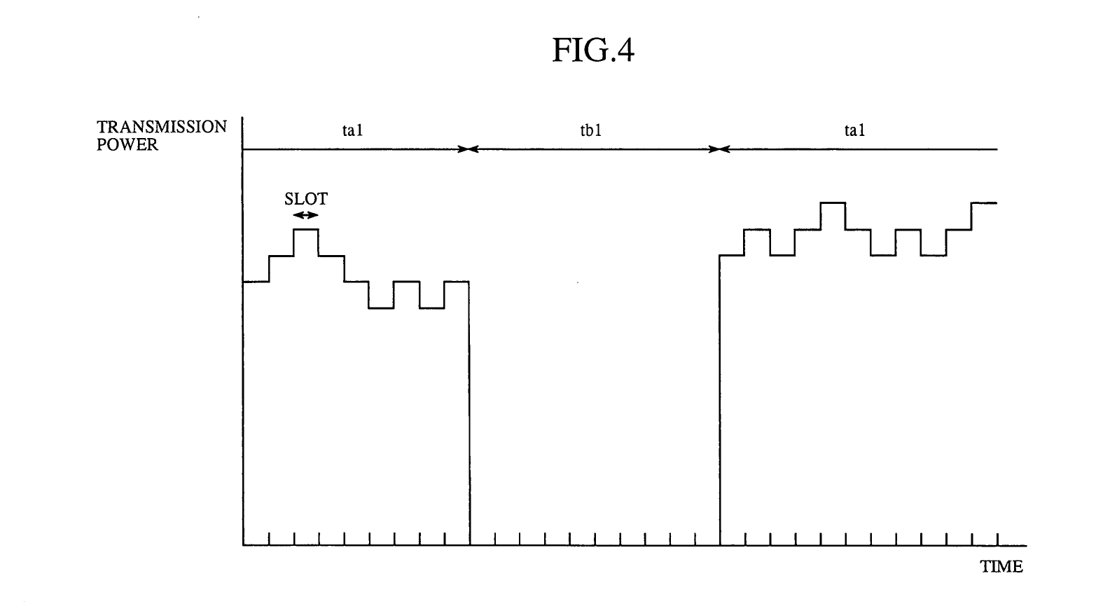

Furthermore, to minimize the variations in the service quality depending on the distance between the MS and BTS, the controller 11 controls the transmission power of the radio transmitting section 15 in accordance with the distance from the MS. As illustrated in FIG. 4, when the radio transmitting section 15 transmits frames, the controller 11 controls the powers of the individual slots. The term “slot” refers to a single transmission control unit with 15 slots corresponding to 10 ms. Since each BTS 2 can communicate with a plurality of MS's, the controller 11 carries out the power control for each spreading code.

The transmission power measuring section 16 measures the transmission power of the individual slots of each frame transmitted by the radio transmitting section 15. The transmission power measuring section 16 measures the transmission power of each spreading code (each MS) using code domain power measurement. Because of the transmission power control described above, the transmission power measured varies from slot to slot as illustrated in FIG. 4. In addition, during the idle period tb1 in the compressed mode, the value of the transmission power of the traffic channel to the MS is very small. Accordingly, sharp differences arise between the transmission powers during the transmission period ta1 and idle period tb1 of the frames in the compressed mode. The transmission power measuring section 16 supplies the measured results to the controller 11.

Returning to FIG. 3, the receiving sub-system 20 includes a controller 21, an error-correcting decoder 22, a deinterleaver 23, a deframing/despreading unit 24, a radio receiving section 25, and a received power measuring section 26. The controller 21 controls the operation of the deinterleaver 23 and deframing/despreading unit 24 according to the control algorithm and negotiation results with the transmitting sub-system 10. The controller 21 carries out the operation suitable for the normal mode and compressed mode, respectively. Specifically, the controller 21 instructs the deframing/despreading unit 24 about the receive processing timing for receiving the compressed mode frames from the MS suitable for the individual modes.

The radio receiving section 25 demodulates the received signal delivered from an antenna not shown. The deframing/despreading unit 24 acquires the demodulated signal from the radio receiving section 25 at the receive processing timing instructed by the controller 21. The deframing/despreading unit 24 despreads the demodulated signal using the spreading code assigned to the user, and generates a received code train from the frames obtained by despreading.

The deinterleaver 23 rearranges the bits of (deinterleaves) the received code train in the order opposite to the interleaving made by the transmitting sub-system 10. The error-correcting decoder 22 obtains the received signal train by performing the error-correcting decoding of the deinterleaved code train.

The received power measuring section 26 measures the transmission power of each slot of the signal received by the radio receiving section 25. The received power measuring section 26 measures the transmission power for each spreading code (each MS) using the code domain power measurement.

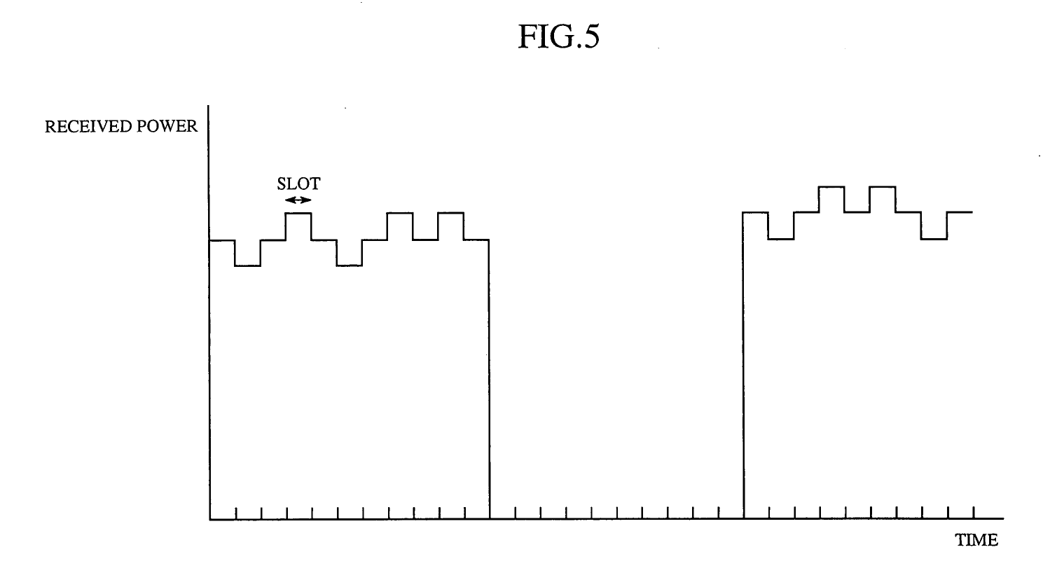

FIG. 5 illustrates transition of the received power measured by the received power measuring section 26. Because of the transmission power control described above, the corresponding MS receives a signal whose power varies from slot to slot. In response to the received power, the MS controls its own transmission power. Since the MS controls the power of each slot in its own transmission power control, the received power measured by the received power measuring section 26 of the BTS 2 also varies depending on the slots as illustrated in FIG. 5. The received power measuring section 26 supplies its measured results to the controller 11 of the transmitting sub-system 10.

From the transition of the transmission power measured by the transmission power measuring section 16 as shown in FIG. 4, the controller 11 can decide the actual transmission start time of each frame unit (the actual stop time of the immediately previous idle period) and transmission stop time of each frame unit (the actual start time of the immediately subsequent idle period).

In addition, from the transition of the received power measured by the received power measuring section 26 as shown in FIG. 5, the controller 11 can decide the actual receiving start time and receiving stop time of the received signal.

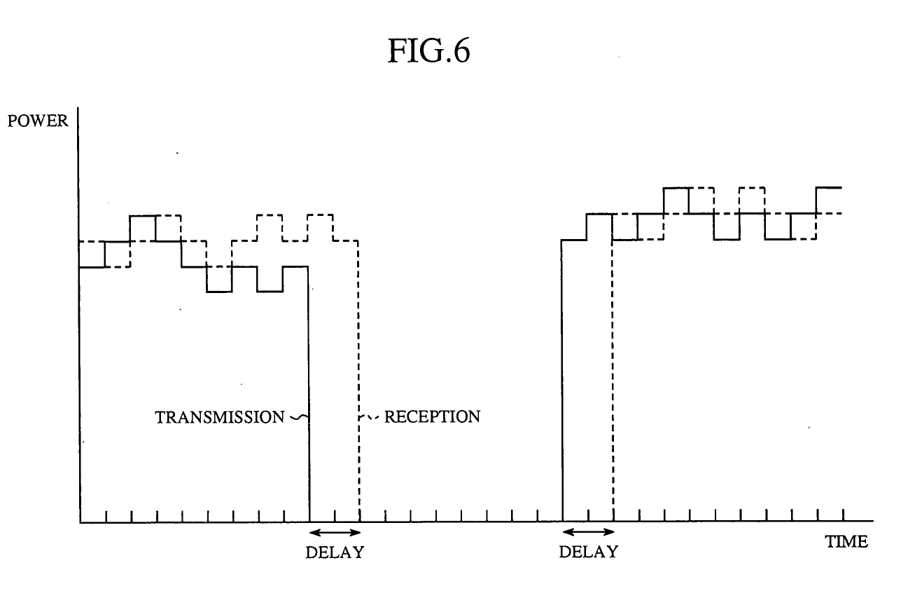

In FIG. 6, solid lines indicating the transition of the transmission power shown in FIG. 4 are superimposed on broken lines indicating the transition of the received power shown in FIG. 5. In FIG. 6, the difference between the transmission stop time and the receiving stop time arises from the transmission delay between the BTS 2 and MS 3. In addition, the difference between the transmission start time and receiving start time also arises from the transmission delay.

The controller 11, functioning as a calculating section, calculates a value associated with the transmission delay. For example, the controller 11 calculates the difference between the transmission stop time of each frame unit and the receiving stop time of the received signal train corresponding to the frame unit. If the difference is greater than a first threshold value, the controller 11 serves as a correcting section, and corrects the transmission period of the next frame unit. Specifically, it sets the transmission start time of the frame unit ahead of scheduled time.

In addition, if the difference is very large, the MS 3 is considered to have failed to carry out the receive processing of the final portion of the frame unit. Thus, the controller 11 serves as the retransmission control section if the difference is greater than a second threshold value (greater than the first threshold value). Specifically, the controller 11 reads out the frame, which is stored in the buffer 14A and has been transmitted previously, on a priority basis, and delivers the frame to the radio transmitting section 15 at the time to transmit the frame.

As for the value associated with the transmission delay, the difference between the actual idle period of the transmitting section and the idle period of the receiving section affected by the delay can also be used. The controller 11 calculates the actual transmitting section idle period from the actual transmission stop time of each frame unit and the actual transmission start time of the next frame unit. In addition, the controller 11 calculates the receiving section idle period affected by the delay from the actual receiving stop time of each received signal train and the actual receiving start time of the next received signal train. Then, the controller 11 calculates the difference between the transmitting section idle period and the receiving section idle period. When the difference is greater than a third threshold value, the controller 11 serves as the correcting section, and corrects the transmission period of the next frame unit. Specifically, the controller 11 reduces the transmission period (increases the transmission rate) of the frame unit, and instructs the radio transmitting section 15 to increase the transmission power by that amount.

If the difference is very large, the MS 3 is considered to have failed to carry out the receive processing of the final portion of the frame unit. Thus, the controller 11 serves as the retransmission control section if the difference is greater than a fourth threshold value (greater than the third threshold value). Specifically, the controller 11 reads out the frame, which is stored in the buffer 14A and has been transmitted previously, on a priority basis, and delivers the frame to the radio transmitting section 15 at the time to be transmitted. If the difference between the stop times is equal to or less than the second threshold value, and the difference between the idle periods is equal to or less than the fourth threshold value, the controller 11 eliminates the frame, which is considered to have passed through the receive processing successfully in the buffer MS3, is deleted from the buffer 14A to increase its available space.

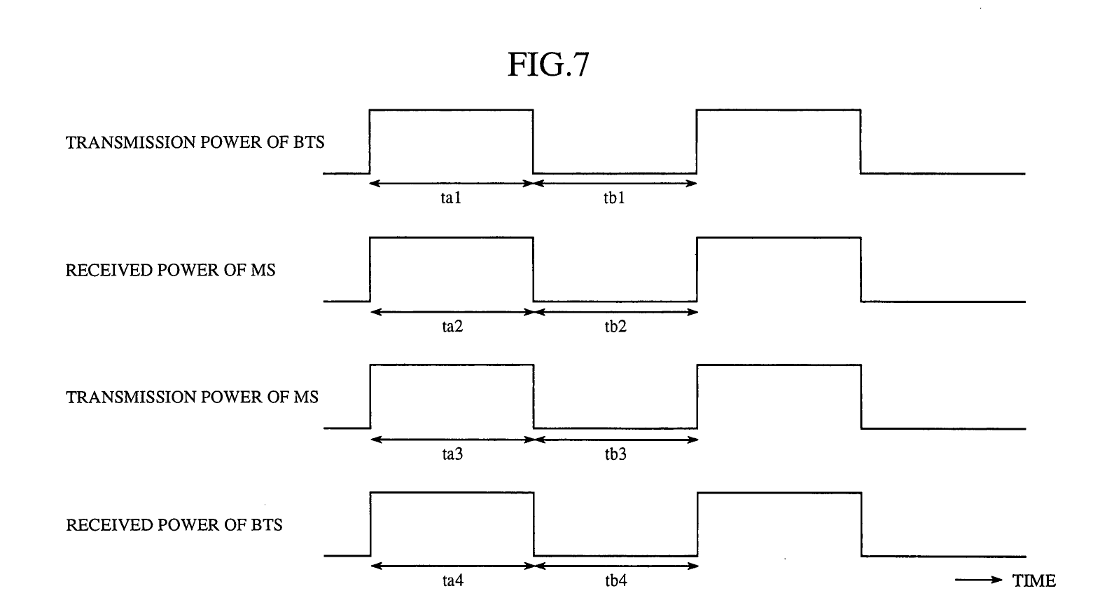

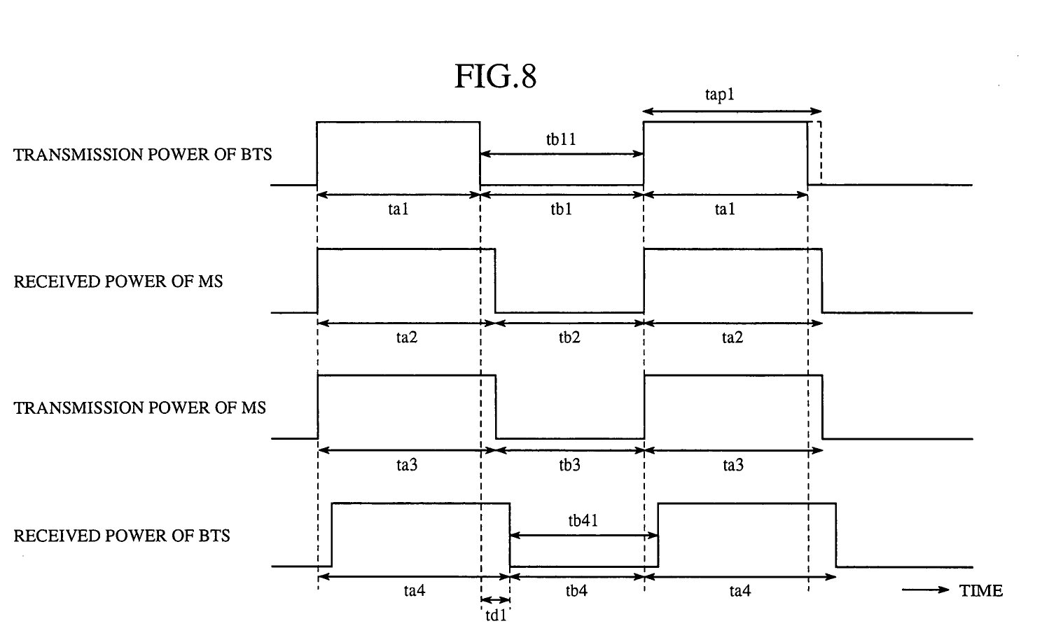

The control of the frame unit during the transmission period in the compressed mode will be described in more detail with reference to FIGS. 7 and 8.

FIG. 7 illustrates transitions of the powers when the transmission delay between the BTS 2 and MS 3 is very small, and FIG. 8 illustrates transitions of the powers when the transmission delay is rather large. In FIG. 7, the variations in the power from slot to slot as illustrated in FIGS. 4-6 are omitted.

As illustrated in FIG. 7, the BTS 2, with which the MS 3 makes current communication using the traffic channel, intermittently transmits the frame units in the compressed mode. The symbol ta1 designates a predetermined transmission period of a frame unit by the BTS 2, and tb1 designates a predetermined pause, that is, an idle period, during which the BTS 2 does not transmit any frame unit.

The MS 3 carries out the receive processing of the frame units on the traffic channel during a predetermined receive processing period ta2 of the frame unit in the MS 3. At the same time, the MS 3 receives the signal on the perch channel between the MS 3 and other BTS's 2, candidates of a new base station, during a predetermined idle period tb2. As for the traffic channel with the BTS 2, sharp differences in the received power occur between the actual receiving periods of the frame units and the idle periods as illustrated in FIG. 7. The MS 3 recognizes the transition of the received power via the traffic channel by the code domain power measurement. If the actual receiving period (received power increased period) of the frame unit is within the predetermined receive processing period ta2 of the frame unit, the MS 3 can carry out the receive processing of the frame unit without any problem.

Furthermore, the MS 3 transmits the signal train to the BTS 2 via the traffic channel during a predetermined transmission period ta3, and halts to transmit the signal train to the BTS 2 during a predetermined idle period tb3. Incidentally, during the transmission period ta3, even if no significant data or speech is present, a signal train is transmitted. Accordingly, an increase in the transmission power is produced intermittently by the MS 3.

In the BTS 2, every time it receives the signal train, the received power increases. Thus, the received power increases during a receive processing period ta4, and reduces during an idle period tb4.

As illustrated in FIG. 7, if the transmission delay between the BTS 2 and MS 3 is very small, the transmission timing of the BTS 2 is synchronized with the receive processing timing of the MS 3, thereby preventing the loss of the frame unit.

In contrast with this, if the transmission delay is rather great as illustrated in FIG. 8, the actual receiving period (received power increased period) of the frame units in the MS 3 is lengthened or delayed. When the actual receiving period of the frame unit is within the predetermined receive processing period ta2 of the frame unit, the MS 3 can carry out the receive processing of the frame unit without any problem. However, if the actual receiving period exceeds the predetermined receive processing period ta2 of the frame unit, the MS 3 cannot carry out the receive processing of the frame unit successfully. In addition, even if the MS 3 can perform the receive processing of the current frame unit without problem, if the actual receiving period of the current frame unit is close to the boundary of the predetermined receive processing period ta2 of the frame unit, the reliability of the receive processing of the next frame unit is low.

The MS 3 transmits a signal train to the BTS 2 using a traffic channel in the predetermined transmission period ta3. In the present embodiment, the transmission power in each slot of the signal train transmitted from the MS 3 during each transmission period ta3 is affected by the transmission power of each slot of the frame unit transmitted by the BTS 2. This is because the BTS 2 carries out the transmission power control of each slot, and the MS 3 controls the transmission power of each slot in response to the received power. Accordingly, among the slots during the transmission period ta3, the slot whose power is affected by the final slot of the frame unit transmitted by the BTS 2, is also delayed.

As for the BTS 2, every time it receives the signal train, the received power increases, and the actual receiving period (received power increased period) of the signal train is also lengthened or delayed because of the transmission delay. As described above, the transmission power of each slot of the signal train transmitted from the MS 3 is affected by the transmission power of each slot of the frame unit transmitted by the BTS 2. Accordingly, the BTS 2 can identify, among the slots of the signal train received in each receiving period, the final slot affected by the transmission power among the slots of the frame unit transmitted by the BTS 2. Thus, the BTS 2 can identify the actual receiving period of the signal train.

If the actual receiving period of the signal train is within the predetermined receive processing period ta4 of the signal train, the BTS 2 can carry out the receive processing of the signal train without fail. However, if the actual receiving period of the signal train exceeds the predetermined receive processing period ta4 of the signal train, the BTS 2 cannot perform the receive processing of the signal train successfully. In this case, it is highly probable that the MS 3 has not been able to carry out the receive processing of the frame unit successfully, as well.

In addition, even if the BTS 2 can carryout receive processing of the current signal train without fail, if the actual receiving period of the current signal train is close to the boundary of the predetermined receive processing period ta4 of the signal train, the reliability of the receive processing of the next signal train is low. In this case, it is highly probable that the MS 3 cannot achieve the receive processing of the next frame unit successfully.

In view of this, the controller 11 of the BTS 2 calculates the difference td1 between the transmission stop time of each frame unit and the receiving stop time of the received signal train corresponding to the frame unit. If the difference td1 is greater than the first threshold value, the controller 11 sets the transmission start time of the next frame unit ahead of scheduled time. This makes it possible for the MS 3 to complete the actual receiving period of the frame unit (received power increased period) earlier enough than the prescribed receive processing period ta2 of the frame unit in the MS 3. Likewise, this makes it possible for the BTS 2 to complete the actual receiving period of the signal train earlier enough than the prescribed receive processing period ta4 of the signal train in the BTS 2. Unless the transmission delay is large, advancing the transmission start time of the next frame unit enables the MS 3 to complete the entire receive processing of the signal train within the prescribed receive processing period ta2. In addition, it is not necessary for the MS 3 to change the scheduled receive processing timing.

If the difference td1 is greater than the second threshold value (which is greater than the first threshold value), in which case the MS 3 is considered to have failed to carry out the receive processing of the final portion of the frame unit, the controller 11, which serves as the retransmission control section, reads out, on a priority basis, the frame that is stored in the buffer 14A and has been transmitted previously, and supplies the frame to the radio transmitting section 15 at the time to be transmitted. In addition, the controller 11 sets the transmission start time of the next frame unit (frame unit to be retransmitted) ahead of scheduled time in the same manner as described above. Thus, the frame unit whose receive processing has failed in the MS 3 is retransmitted so that the MS 3 can carry out the receive processing under improved reliability.

Furthermore, the controller 11 of the BTS 2 calculates the actual transmitting section idle period tb11 from the actual transmission stop time of each frame unit and the actual transmission start time of the next frame unit. In addition, the controller 11 calculates the receiving section idle period tb41 affected by the delay from the actual receiving stop time of each received signal train and the actual receiving start time of the next received signal train. Then the controller 11 calculates the difference between the transmitting section idle period and the receiving section idle period(=tb11−tb41). The difference greater than the third threshold value means that the actual receiving period (received power increased period) of the frame unit at the MS 3 is longer than the prescribed receive processing period ta2. In such a case, the controller 11 reduces the transmission period ta1 of the next frame unit (sets the transmission stop time ahead of scheduled time), and instructs the radio transmitting section 15 to increase the transmission power by that amount. In FIG. 8, the symbol tap1 designates the transmission period scheduled before the change.

By this change, the actual receiving period (received power increased period) of the frame unit at the MS 3 is made shorter enough than the prescribed receive processing period ta2 of the frame unit at the MS 3. Likewise, the actual receiving period of the signal train at the BTS 2 is made shorter enough than the prescribed receive processing period ta4 of the signal train at the BTS 2. Unless the transmission delay is large, the MS 3 can complete the entire receive processing of the signal train during the prescribed receive processing period ta2 by advancing the transmission stop time of the next frame unit. Further, it is not necessary for the MS 3 to alter the scheduled receive processing timing.

If the difference(=tb11−tb41) is greater than the fourth threshold value (which is greater than the third threshold value), in which case the MS 3 is considered to have failed to carry out the receive processing of the final portion of the frame unit, the controller 11, which serves as the retransmission control section, reads out, on a priority basis, the frame that is stored in the buffer 14A and has been transmitted previously, and supplies the frame to the radio transmitting section 15 at the time to be transmitted. In addition, the controller 11 sets the transmission start time of the next frame unit (frame unit to be retransmitted) ahead of scheduled time in the same manner as described above. Thus, the frame unit whose receive processing has failed in the MS 3 is retransmitted so that the MS 3 can carry out the receive processing under improved reliability.

As described above, the present embodiment 1 can correct the transmission period of the signal train in the compressed mode in response to the transmission delay. Accordingly, it can adjust the transmission period of the frame unit sent from the current BTS 2 to the MS 3 in the compressed mode such that the mobile station can perform the receive processing. Thus, it can prevent or suppress partial corruption of the frame unit sent from the current BTS 2 to the MS 3 in the compressed mode. In addition, to achieve the benefit, it is not necessary for the MS 3 to alter the receive processing timing, which is an advantage of the present embodiment.

Furthermore, if the value associated with the transmission delay exceeds the second threshold value or fourth threshold value, retransmitting the frame unit to the MS 3 enables the frame unit whose receive processing has failed in the MS 3, to be retransmitted and subjected to the receive processing at the MS 3 under improved reliability.

### Embodiment 2

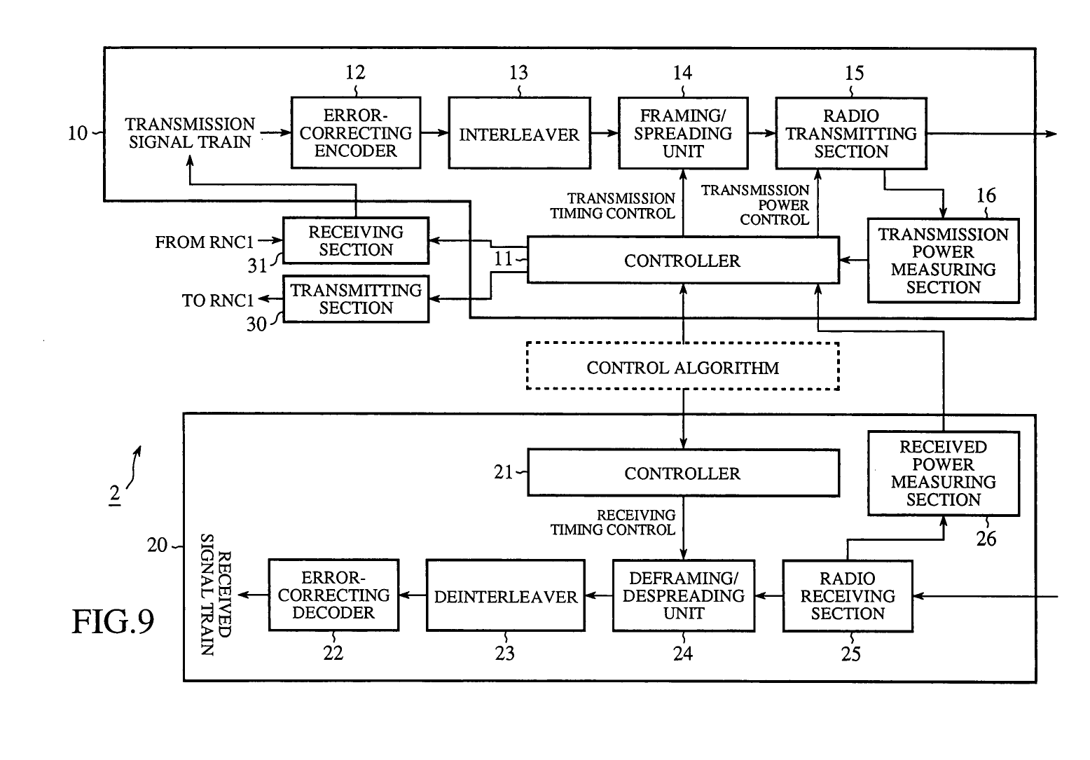

FIG. 9 shows a part of the internal configuration of the BTS 2 of the embodiment 2. In FIG. 9, the reference numeral 30 designates a transmitting section (retransmission signal train request section), and 31 designates a receiving section (retransmission signal train receiving section). The transmitting section 30 is provided for transmitting a signal to the RNC 1, and the receiving section 31 is provided for receiving a signal from the RNC 1. Although the transmitting section 30 and receiving section 31 are not shown in FIG. 3, the BTS 2 of the embodiment 1 has also the transmitting section 30 and receiving section 31 for the normal communication with the RNC 1.

In FIG. 9, the same components as those of FIG. 3 are designated by the same reference numerals, and their detailed description is omitted here. In the present embodiment, when the BTS 2 utilized by the current MS 3 enters into the compressed mode, the signal train to be transmitted from the current BTS 2 to the MS 3 is transmitted to the RNC 1 once, stored in a buffer of the RNC 1 not shown, and is transmitted from the RNC 1 to the current BTS 2. The receiving section 31 receives the signal train, and delivers it to the error-correcting encoder 12. The error-correcting encoder 12, interleaver 13 and framing/spreading unit 14 operate in the same manner as in the embodiment 1.

The controller 11 supplies the frame to be transmitted which is generated by the framing/spreading unit 14 to the radio transmitting section 15 at the time to be transmitted. The radio transmitting section 15 transmits the frame to the MS at the radio frequency of the traffic channel. In this way, the controller 11 controls the transmission timing to implement the frame transmission matching the individual modes. In addition, the controller 11 controls the transmission rate and transmission power of the radio transmitting section 15.

As the embodiment 1, the present embodiment also controls the transmission period of the frame unit in the compressed mode according to the transmission power at the radio transmitting section 15 and the received power at the radio receiving section 25 (see FIGS. 4-8). The present embodiment, however, utilizes the RNC 1 for the retransmission of the frame unit from the BTS 2 to the MS 3.

More specifically, if the difference td1 of the stop time described with reference to FIG. 8 is greater than the second threshold value, in which case the MS 3 is considered to have failed to carry out the receive processing of the final portion of the frame unit, the controller 11 generates a retransmission signal train request for requesting the RNC 1 to send the signal train for retransmitting the frame unit to the MS 3, and delivers the retransmission signal train request to the transmitting section 30. The transmitting section 30, which serves as the retransmission signal train request section, transmits the retransmission signal train request to the RNC 1.

Receiving the retransmission signal train request, the RNC 1 reads out the transmission signal train which is stored in the buffer (not shown) of the RNC 1 and has been transmitted before, and transmits the transmission signal train to the BTS 2. In the BTS 2, the receiving section 31, which serves as a retransmission signal radio receiving section, receives from the RNC 1 the signal train to be retransmitted. After that, the transmission signal train undergoes framing/spreading. The controller 11, which serves as the retransmission control section, controls the radio transmitting section 15 such that it retransmits the frame to be retransmitted. Specifically, the controller 11 delivers the frame to be retransmitted generated by the framing/spreading unit 14 to the radio transmitting section 15 at the time to be transmitted, and controls the transmission timing to carry out the frame transmission matching the compressed mode. In addition, the controller 11 controls the transmission rate and transmission power of the radio transmitting section 15.

In the case of the retransmission, the controller 11 sets the transmission start time of the next frame unit (frame unit to be retransmitted) ahead of scheduled time. Thus, the frame unit whose receive processing has failed in the MS 3 is retransmitted so that the MS 3 can carry out the receive processing under improved reliability.

If the difference(=tb11−tb41) between the idle periods described with reference to FIG. 8 is greater than the fourth threshold value, in which case the MS 3 is considered to have failed to carry out the receive processing of the final portion of the frame unit, the controller 11 generates the retransmission signal train request for requesting the RNC 1 to send the signal train for retransmitting the frame unit to the MS 3, and delivers the retransmission signal train request to the transmitting section 30. Thus, the signal train to be retransmitted is delivered from the RNC 1 to the receiving section 31 of the BTS 2 in the same manner as described above, and the frame unit is retransmitted from the BTS 2 to the MS 3. In the case of the retransmission, the controller 11 also sets the transmission stop time of next frame unit (frame unit to be retransmitted) ahead of scheduled time. Thus, the frame unit whose receive processing has failed in the MS 3 is retransmitted so that the MS 3 can carry out the receive processing under improved reliability.

If the difference td1 between the stop times is equal to or less than the second threshold value, and the difference between the idle periods(=tb11−tb41) is equal to or less than the fourth threshold value, the controller 11 notifies the RNC 1 of the frame whose receive processing is considered to have been successful at the buffer MS 3, through the transmitting section 30. The RNC 1 deletes the frames from the buffer to increase its available space.

As described above, the present embodiment 2 can prevent or suppress partial corruption of the frame unit sent from the current BTS 2 to the MS 3 in the compressed mode. In addition, to achieve the benefit, it is not necessary for the MS 3 to alter the receive processing timing, which is an advantage of the present embodiment.

In addition, if the value associated with the transmission delay exceeds the second threshold value or fourth threshold value, retransmitting the frame unit to the MS 3 enables the frame unit whose receive processing has failed in the MS 3, to be retransmitted and subjected to the receive processing at the MS 3 under improved reliability.

### Embodiment 3

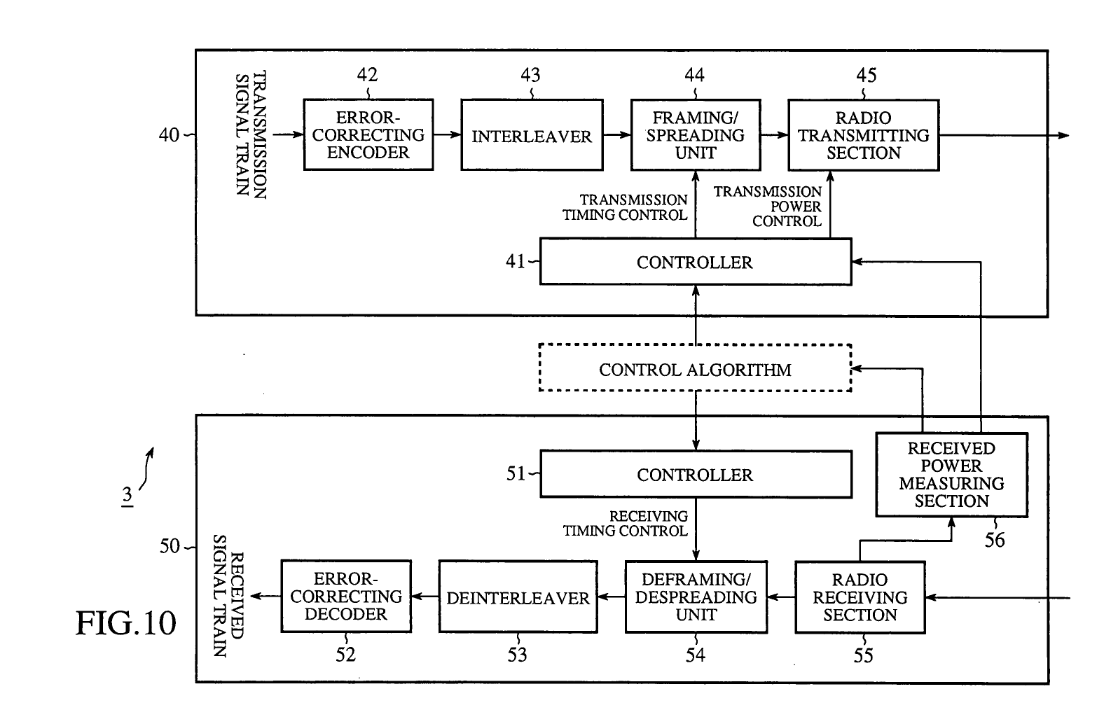

FIG. 10 shows part of the internal configuration of the MS 3 of the embodiment 3. In FIG. 10, the reference numeral 40 designates a transmitting sub-system and 50 designates a receiving sub-system. The transmitting sub-system 40 includes a controller 41, an error-correcting encoder 42, an interleaver 43, a framing/spreading unit 44, and a radio transmitting section 45.

The controller 41 controls the operation of the interleaver 43, framing/spreading unit 44, and radio transmitting section 45 according to a control algorithm and negotiation results with the receiving sub-system 50. The controller 41 carries out the normal mode (non-compressed mode) and compressed mode.

The error-correcting encoder 42 conducts the error-correcting coding of the transmission signal train to produce a transmission code train. The interleaver 43 rearranges the order of the bits of (interleaves) the transmission code train in order to minimize the effect of a transmission error that will occur when continuous bits in the transmission code train are lost because of fading during the transmission, for example.

The framing/spreading unit 44 spreads the transmission code train to a wide bandwidth using a spreading code assigned to each user. In addition, the framing/spreading unit 44 generates frames on the basis of the spread transmission code train.

The controller 41 delivers the frames, which are generated by the framing/spreading unit 44 and are to be transmitted, to the radio transmitting section 45 at the time of transmission. The radio transmitting section 45 transmits the frames to the BTS 2 at the radio frequency of the traffic channel. In this way, the controller 41 controls the transmission timing to carry out the frame transmission suitable for the individual modes.

In addition, the controller 41 controls the transmission rate and transmission power of the radio transmitting section 45. Specifically, the controller 41 specifies in the compressed mode the transmission rate twice the transmission rate in the normal mode, and the transmission power about twice that of the normal mode.

Furthermore, to minimize the variations in the service quality depending on the distance between the MS and BTS, the controller 41 controls the transmission power of the radio transmitting section 45 in accordance with the distance from the current BTS 2. To achieve this, the measured results are used of a received power measuring section 56 of the receiving sub-system 50. As described above, because of the transmission power control of each slot by the BTS 2, the signal train received by a radio receiving section 55 of the receiving sub-system 50 has the power varying from slot to slot. The controller 41 controls the transmission power of the radio transmitting section 45 in response to the received power measured by the received power measuring section 56. Accordingly, the transmission power of the radio transmitting section 45 varies from slot to slot as illustrated in FIG. 5.

The receiving sub-system 50 includes a controller (mode control section, calculating section, and correcting section) 51, an error-correcting decoder 52, a deinterleaver 53, a deframing/despreading unit 54, a radio receiving section 55, and the received power measuring section 56. In addition, although not shown, the MS 3 includes a processing unit for carrying out the processing for determining the new BTS 2 to be used after a hard handover. The deframing/despreading unit 54, deinterleaver 53, error-correcting decoder 52 and processing unit constitute a receive processing section for processing the signal train received by the radio receiving section 55.

The radio receiving section 55 demodulates the received signal delivered from an antenna not shown. The deframing/despreading unit 54 acquires the demodulated signal from the radio receiving section 55 at the receive processing timing instructed by the controller 51. The deframing/despreading unit 54 despreads the demodulated signal using the spreading code assigned to the user, and generates a received code train from the frame obtained by the despreading.

The deinterleaver 53 rearranges the bits of (deinterleaves) the received code train in the order opposite to the interleaving by the transmitting sub-system 40. The error-correcting decoder 52 obtains the received signal train by performing the error-correcting decoding of the deinterleaved code train.

The received power measuring section 56 measures the transmission power of each slot of the received signal received by the radio receiving section 55.

The controller 51 controls the operation of the deinterleaver 53 and deframing/despreading unit 54 according to the control algorithm and negotiation results with the transmitting sub-system 40. The controller 51 carries out the operation suitable for the normal mode and compressed mode, respectively. Specifically, the controller 51 instructs the deframing/despreading unit 54 about the receive processing timing for receiving the compressed mode frames from the BTS 2 suitable for the individual modes.

In the compressed mode, the controller 51 instructs the deframing/despreading unit 54 about the receive processing timing so that the deframing/despreading unit 54 carries out the deframing/despreading of the frame units intermittently. This makes it possible for the receive processing section to intermittently process the signal train sent from the current BTS 2. Thus, the processing unit can process signals from candidates of the new BTS 2 during the idle period during which the radio receiving section 55 does not receive the signal train from the current BTS 2. This enables the processing unit to carry out the receive processing for determining the new BTS 2 used after the hard handover.

The MS 3 with a similar configuration is also used in the foregoing embodiments 1 and 2. The MS 3 of the present embodiment, however, has the controller 51 control the receive processing period of the frame units sent from the current BTS 2 in the compressed mode according to the measured results by the received power measuring section 56.

When the transmission delay between the BTS 2 and MS 3 is very small, the transitions of the powers are similar to those of the chart of FIG. 7. In this case, since the transmission timing of the BTS 2 is synchronized with the receive processing timing of the MS 3, there is no fear that the frame unit is lost.

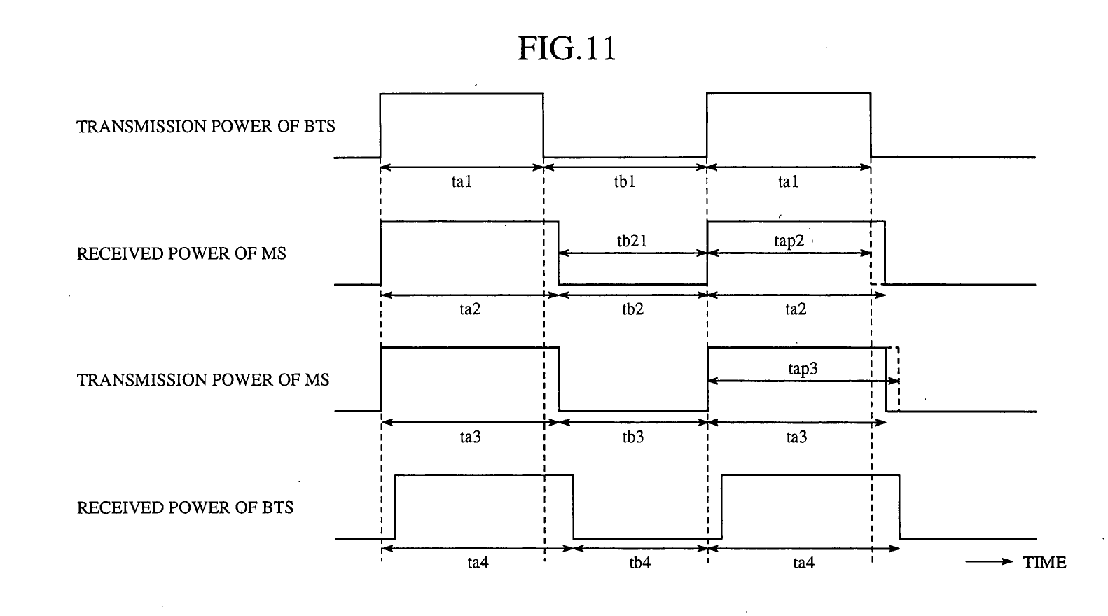

However, when the transmission delay is rather large as illustrated in FIG. 11, the actual receiving period (received power increased period) of the frame unit at the MS 3 is lengthened or delayed. If the actual receiving period of the frame unit is within the predetermined receive processing period ta2 of the frame unit, the MS 3 can perform the receive processing of the frame unit without any problem. However, if the actual receiving period of the frame unit exceeds the predetermined receive processing period ta2 of the frame unit, the MS 3 cannot carry out the receive processing of the frame unit successfully. In addition, even if the MS 3 can perform the receive processing of the current frame unit without problem, if the actual receiving period of the current frame unit is close to the boundary of the predetermined receive processing period ta2 of the frame unit, the reliability of the receive processing of the next frame unit is low.

Thus, the controller 51 of the receiving sub-system 50 of the MS 3, which serves as the calculating section, calculates the value associated with the transmission delay from the measured results by the radio receiving section 55. Specifically, the controller 51 calculates the difference tb21 between the actual receiving stop time of each frame unit and the actual receiving start time of the next frame unit. The difference tb21 is the actual receiving section idle period affected by the delay.

Furthermore, the controller 51 corrects receive processing period ta2 of the next frame unit in accordance with the actual receiving section idle period tb21. Specifically, if the actual receiving section idle period tb21 is smaller than a fifth threshold value, which means that the actual receiving period (received power increased period) of the frame unit is longer than the prescribed receive processing period ta2 at the MS 3, the controller 51 controls the receive processing section such that it prolongs the receive processing period ta2 (sets the receive processing stop time behind scheduled time) of the next frame unit. For example, it prolongs the period during which it instructs the deframing/despreading unit 54 about the receive processing timing. The symbol tap2 in FIG. 11 designates the receive processing period scheduled until the change takes place.

By this change, the prescribed receive processing period ta2 of the frame unit at the MS 3 is made sufficiently longer than the actual receiving period (received power increased period) of the frame unit at the MS 3. Unless the transmission delay is large, the MS 3 can complete the entire receive processing of the signal train within the prescribed receive processing period ta2 by delaying the receive processing stop time of the next frame unit. Further, it is not necessary for the BTS 2 to alter the scheduled transmission timing.

In addition, when the actual receiving section idle period tb21 is greater than a sixth threshold value (which is greater than the fifth threshold value), in which case the MS 3 is considered to have failed to carry out the receive processing of the final portion of the frame unit, the controller 51 works on the controller 41 of the transmitting sub-system 40 so that the transmitting sub-system 40 transmits a retransmission request to the BTS 2. In addition, the controller 51 sets the receive processing stop time of the next frame unit (frame unit to be retransmitted) ahead of scheduled time in the same manner as described above. Thus, when the frame unit whose receive processing has failed in the MS 3 is retransmitted, the MS 3 can carry out the receive processing under improved reliability.

The MS 3 of the present embodiment can be configured such that the controller 41 of the transmitting sub-system 40 controls the actual transmission period of the frame unit sent to the current BTS 2 in the compressed mode according to the measured results of the received power measuring section 56. For example, if the actual receiving section idle period tb21 affected by the delay is less than the fifth threshold value, the controller 41 instructs the radio transmitting section 45 to reduce the actual transmission period ta3 (to set the transmission stop time ahead of schedule) of the next frame unit at the MS 3, and to increase the transmission power by that amount. In FIG. 11, the symbol tap3 designates the transmission period scheduled before the change.

By this change, the actual receiving period of the frame unit (received power increased period) at the BTS 2 is made shorter enough than the prescribed receive processing period ta4 of the frame unit at the BTS 2. Accordingly, advancing the transmission stop time of the next frame unit enables the BTS 2 to complete the entire receive processing of the signal train during the prescribed receive processing period ta4 by advancing the transmission stop time of the next frame unit. Further, it is not necessary for the BTS 2 to alter the scheduled receive processing timing.

As described above, according to the present embodiment 3, the MS 3 can correct the receiving period of the signal train in the compressed mode in response to the transmission delay. Accordingly, the MS 3 can adjust the receiving period of the frame unit sent from the current BTS 2 to the MS 3 in the compressed mode such that the MS 2 can perform the receive processing of the frame unit. Thus, it can prevent or suppress partial corruption of the signal train. In addition, to achieve the benefit, it is not necessary for the BTS 2 to alter the scheduled transmission timing, which is an advantage of the present embodiment.

In addition, the MS 3 can perform the adjustment to delay the receive processing stop time of the frame unit in response to the receiving section idle period tb21. Even if the transmission delay is present, as long as it is not large, delaying the receive processing stop time enables the MS 3 to complete the entire receive processing of the frame unit during the modified receive processing period ta2.

It is also possible to combine the MS 3 of the present embodiment with the BTS 2 of the embodiment 1 or 2. In this case, the advantages of both the MS 3 and BTS 2 can be achieved.

In addition, although the foregoing embodiments utilize the compressed mode to carryout the frequency switching handover, it is not intended to limit the present invention to the foregoing disclosure. The present invention is applicable to other types of hard handover.

The present invention has been described in detail with respect to preferred embodiments using the drawings, and it will now be apparent from the foregoing to those skilled in the art that changes and modifications in forms and details may be made without departing from the substance and limits of the invention described in claims. Therefore it is the intention in the apparent claims to cover all such changes and modifications.

### INDUSTRIAL APPLICABILITY

As described above, according to the present invention, it is possible to prevent or suppress the partial corruption of a frame unit sent from the current base station to the mobile station in the compressed mode.

1. A base station for radio communication comprising:
a radio transmitting section for transmitting a signal train to a mobile station;
a radio receiving section for receiving a signal train from said mobile station;
a mode control section for controlling said radio transmitting section in a manner that implements a compressed mode to enable communication for determining a new base station said mobile station uses after a hard handover, said compressed mode being a mode in which said radio transmitting section transmits the signal train intermittently to said mobile station;
a transmission power measuring section for measuring transmission power at which said radio transmitting section transmits the signal train;
a received power measuring section for measuring received power of the signal train received by said radio receiving section;
a calculating section for calculating a value associated with transmission delay from measured results of said transmission power measuring section and said received power measuring section; and
a correcting section for correcting a transmission period of the signal train in the compressed mode in response to the value associated with the transmission delay.

2. The base station according to claim 1, wherein
said calculating section calculates a difference between a transmission stop time of the signal train transmitted by said radio transmitting section and a receiving stop time of the signal train which corresponds to the signal train and is received by said radio receiving section, and
said correcting section sets a transmission start time of the signal train transmitted by said radio transmitting section ahead of scheduled time in response to the difference.

3. The base station according to claim 1, wherein
said calculating section calculates a transmitting section idle period during which said radio transmitting section does not actually transmit the signal train, calculates a receiving section idle period during which said radio receiving section does not actually receive the signal train, and calculates a difference between the transmitting section idle period and the receiving section idle period, and
said correcting section sets a transmission stop time of the signal train transmitted by said radio transmitting section ahead of scheduled time in response to the difference.

4. The base station according to claim 1, further comprising a retransmission control section for controlling said radio transmitting section in a manner that said radio transmitting section retransmits the signal train to said mobile station if the value associated with the transmission delay exceeds a threshold value.

5. The base station according to claim 1, further comprising:
a retransmission signal train request section for asking a radio network controller for a signal train to be retransmitted to said mobile station when the value associated with the transmission delay exceeds a threshold value;
a retransmission signal radio receiving section for receiving the signal train to be retransmitted from said radio network control unit; and
a retransmission control section for controlling said radio transmitting section in a manner that said radio transmitting section retransmits the signal train to be retransmitted to said mobile station.

6. A radio communication method in a base station for radio communication comprising the steps of:
transmitting a signal train from a radio transmitting section to a mobile station;
receiving a signal train from said mobile station by a radio receiving section;
controlling said radio transmitting section in a manner that implements a compressed mode to enable communication for determining a new base station said mobile station uses after a hard handover, said compressed mode being a mode in which said radio transmitting section transmits the signal train intermittently to said mobile station;
measuring transmission power at which said radio transmitting section transmits the signal train;
measuring received power of the signal train received by said radio receiving section;
calculating a value associated with transmission delay from the transmission power and received power measured; and
correcting a transmission period of the signal train in the compressed mode in response to the value associated with the transmission delay.

7. A mobile station for radio communication comprising:
a radio transmitting section for transmitting a signal train to a base station;
a radio receiving section for receiving a signal train from said base station;
a receive processing section for processing the signal train received by said radio receiving section;
a mode control section for controlling said receive processing section in a manner that said receive processing section processes the signal train from the current base station intermittently to implement a compressed mode that enables said receive processing section to carry out receive processing for determining a new base station used after a hard handover, said compressed mode being a mode in which said receive processing section processes signals from candidates of the new base station during a pause in which said radio receiving section does not receive the signal train from said current base station;
a received power measuring section for measuring received power of the signal train received by said radio receiving section;
a calculating section for calculating a value associated with transmission delay from measured results of said received power measuring section; and
a correcting section for correcting a period of receive processing of the signal train sent from said current base station, which receive processing is carried out by said receive processing section in the compressed mode in response to the value associated with the transmission delay.

8. The mobile station according to claim 7, wherein
said calculating section calculates a receiving section idle period during which said radio receiving section does not actually receive the signal train; and
said correcting section sets a receive processing stop time of the signal train processed by said receive processing section behind scheduled time in response to the receiving section idle period.
